(19) United States
(12) Patent Application Publication
(10) Pub. No.: US 2026/0333447 A1
(43) Pub. Date: Oct. 22, 2026

(54) SLICE GROUP -SPECIFIC CONNECTED RACH CONFIGURATION

(71) Applicant: Nokia Technologies Oy, Espoo (FI)

(72) Inventors: Halit Murat GÜRSU, Munich (DE); Philippe GODIN, Massy (FR); Ugur Baran ELMALI, Munich (DE); Ömer BULAKCI, Munich (DE); Muhammad NASEER-UL-ISLAM, Munich (DE); Ahmad AWADA, Munich (DE); Malgorzata TOMALA, Wroclaw (PL)

(21) Appl. No.: 19/115,837

(22) PCT Filed: Oct. 6, 2023
(86) PCT No.: PCT/EP2023/077678

§ 371 Date: Mar. 27, 2025

(30) Foreign Application Priority Data
Oct. 10, 2022 (FI) 20225914

(51) Int. Cl. H04W 74/0833; H04W 36/00

(52) U.S. Cl. CPC H04W 74/0833; H04W 36/0072

(57) ABSTRACT

According to an aspect, there is provided an apparatus for performing the following. The apparatus receives, from a first radio access network node, a network slice to network slice access stratum group mapping of a second cell being a target cell of a handover. The second cell is provided by a second radio access network node. The apparatus determines a network slice access stratum group for accessing the second cell based on the network slice to network slice access stratum group mapping of the second cell. The apparatus selects a random access channel resource for accessing the second cell based on the network slice access stratum group and accesses the second cell using the random access channel resource.

### TECHNICAL FIELD

Various example embodiments relate to wireless communications.

### BACKGROUND

Network slicing is a key 5G feature for supporting different services using the same underlying mobile network infrastructure. Network slices can differ either in their service requirements like Ultra-Reliable Low Latency Communication (URLLC) and enhanced Mobile Broadband (eMBB) or the tenant that provides those services. A network slice may be uniquely identified via its S-NSSAI (Single-Network Slice Selection Assistance Information).

A given distributed unit (DU) of a distributed access node may have a set of network slice access stratum (AS) group-specific radio access channel (RACH) resources configured through operations, administration and management (OAM). The mapping between network slice(s) and network slice AS group(s) may be tracking area (TA)-specific. Moreover, each neighbor cell with a different TA may be configured with a different network slice to network slice AS group mapping. In a handover scenario, the terminal device should be aware and take into account the network slice to network slice AS group mapping of the neighbor cell to ensure correct RACH resource use in the terminal device and to avoid service level agreement (SLA) violations. However, no such information is available to the terminal device.

### BRIEF DESCRIPTION

According to an aspect, there is provided the subject matter of the independent claims. Embodiments are defined in the dependent claims.

According to an aspect, there is provided a method comprising:
determining that a handover of a terminal device from a first cell provided by a first access node to a second cell provided by a second access node is to be carried out; and
transmitting a network slice to network slice access stratum group mapping of the second cell to the first access node.

According to an aspect, there is provided a computer program product, embodied on a non-transitory computer readable medium, comprising program instructions, that when run is adapted to perform:
determining that a handover of a terminal device from a first cell provided by a first access node to a second cell provided by a second access node is to be carried out; and
transmitting a network slice to network slice access stratum group mapping of the second cell to the first access node.

One or more examples of implementations are set forth in more detail in the accompanying drawings and the description below. Other features will be apparent from the description and drawings, and from the claims.

### BRIEF DESCRIPTION OF DRAWINGS

In the following, example embodiments will be described in greater detail with reference to the attached drawings, in which

FIGS. 1 and 2 illustrate exemplified wireless communication systems;

FIGS. 3 to 8 illustrate exemplary processes according to embodiments; and

FIGS. 9 to 11 illustrate apparatuses according to embodiments.

### DETAILED DESCRIPTION OF SOME EMBODIMENTS

The following embodiments are only presented as examples. Although the specification may refer to “an”, “one”, or “some” embodiment(s) and/or example(s) in several locations of the text, this does not necessarily mean that each reference is made to the same embodiment(s) or example(s), or that a particular feature only applies to a single embodiment and/or example. Single features of different embodiments and/or examples may also be combined to provide other embodiments and/or examples.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UT-RAN or E-UTRAN), long term evolution (LTE, the substantially same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

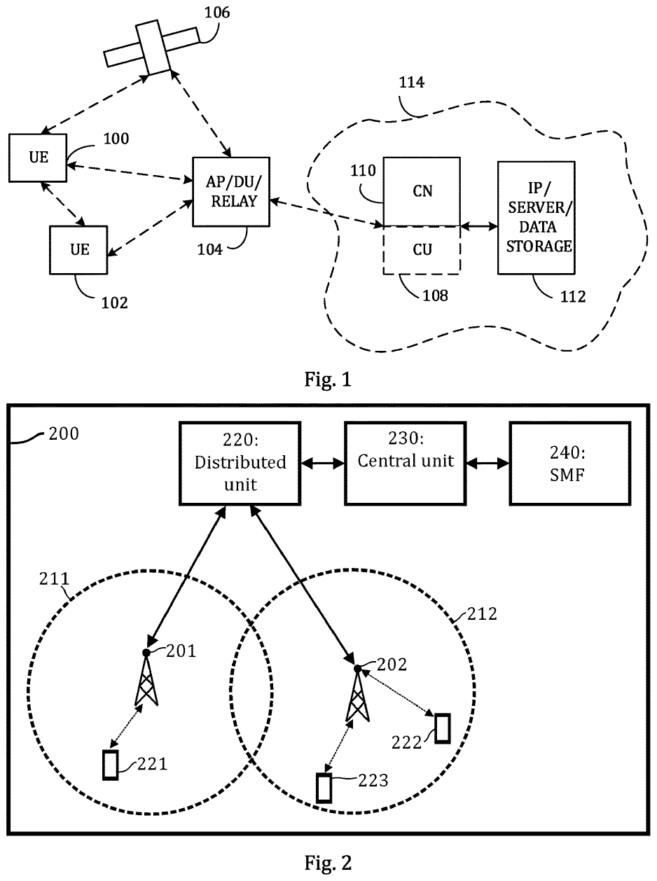

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of inter-connected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

It should be understood that, in FIG. 1, user devices are depicted to include 2 antennas only for the sake of clarity. The number of reception and/or transmission antennas may naturally vary according to a current implementation.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the substantially same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a central or centralized unit, CU 108).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are needed to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G will include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

FIG. 2 illustrates another example of a communications system 200 to which some embodiments may be applied. Specifically, the illustrated communications system employs a disaggregated RAN architecture, where the RAN functionalities are distributed between different distinct units forming the RAN. In other words, the RAN protocol stack is effectively split into multiple RAN protocol stacks so that the individual components can be realized independently. The communications system 200 may correspond the communication system as discussed in relation to FIG. 1 or a part thereof. Therefore, any of the terminal devices 221, 222, 223 may correspond to either of elements 100, 102 of FIG. 1. Moreover, the access node 104 of FIG. 1 may correspond to a combination of the elements 201, 202, 220 forming a distributed access node. The illustrated communications system may be based on New Radio (NR) access technology.

Referring to FIG. 2, the communication system 200 comprises two (remote) radio units or radio heads 201, 202 providing respective (neighboring) cells 211, 212, a distributed unit 220 connected to at least one of the remote radio units 201, 202 via wired and/or wireless communications links and a central unit 230 connected to the distributed unit 220 via a wired or wireless communications link. The central unit 230 may be further connected via wired and/or wireless communications link at least to a session management function (SMF) 240. This connection may be provided via one or more other functions or network entities not shown in FIG. 2 (e.g., via a user plane function, UPF, and/or an access management function, AMF).

At least one of the elements 201, 202, 220, 230 may be associated with the substantially same access node (e.g., the substantially same gNB). At least one remote radio unit 201, 202 may be MIMO-capable (i.e., comprise a MIMO antenna array and associated signal processing means for performing beamforming using said MIMO antenna array). Moreover, the communication system 200 comprises a plurality of terminal devices 221, 222, 223 located within said cells 211, 212. In other embodiments, the number of the remote radio units may be different compared to the illustrated example though to fully benefit from the distributed architecture, the access node should comprise at least two remote radio units. While FIG. 2 illustrates a single distributed unit 220 for simplicity, in other embodiments two or more distributed units 220 connected to the substantially same central unit 230 may be provided.

In some embodiments, the CU 230 may comprise two separate units (or sub-units, logical nodes or entities): a control plane entity of the central unit (central unit-control plane, CU-CP) and a user plane entity of the central unit (central unit-user plane, CU-UP). The CU-CP may, for example, host the radio resource control (RRC) and the control plane part of the packet data convergence (PDCP) protocol of the CU 230 while the CU-UP may host the user plane part of the PDCP protocol and the SDAP protocol of the CU 230. The interface between the distributed unit 220 and the central unit 230 may be called an F1 interface. Specifically, the interface between the DU 220 and the CP-CU may be called F1-C interface and the interface between the DU 220 and the UP-CU may be called a F1-U interface. The interface between the CU-CP and the CU-UP may be called an E1 interface.

While FIG. 2 illustrates specifically a disaggregated RAN architecture and some of the embodiments to be discussed below pertain specifically to the disaggregated RAN architecture, other embodiments may apply specifically to a non-disaggregated RAN architecture (i.e., a RAN architecture without CU-DU split).

Either of the communications systems of FIGS. 1 and 2 may support network slicing. Network slicing is a 5G feature for supporting different services using the same underlying mobile network infrastructure. Network slices may differ either in their service requirements like URLLC and eMBB or the tenant that provides those services.

A network slice (or equally just a slice) may be uniquely identified via its S-NSSAI (single-network slice selection assistance information). A given terminal device may be able to be simultaneously connected and served by at most eight network slices corresponding to eight S-NSSAIs, respectively. On the other hand, each cell provided by an access node or a distributed unit of a distributed access node may support tens or even hundreds of network slices. Moreover, a tracking area (TA) comprising a set of (adjacent) cells provided by one or more access nodes may have support for up to 1024 network slices.

The S-NSSAI may comprise or consist of a slice/service type (SST) field (having a length of 8 bits) and a slice differentiator (SD) field (having a length of 24 bits) with a total length of 32 bits. Alternatively, the S-NSSAI may consist of the SST field only in which case the length of S-NSSAI is 8 bits only.

The SST field may have a standardized or non-standardized value. Values 0 to 127 belong to the standardized SST range. For instance, the SST value of 1 may indicate that the slice is suitable for handling of 5G eMBB, 2 for handling of URLLC and so on. The SD field may be operator-defined.

NSSAI (defining one or more individual S-NSSAIs) may comprise information of one or more of the following types:
Allowed NSSAI: NSSAI provided by the serving public land mobile network (PLMN) during, e.g., a registration procedure, indicating the S-NSSAI values the terminal device could use in the serving PLMN for the current registration area (RA).
Configured NSSAI: NSSAI provisioned in the terminal device applicable to one or more PLMNs.
Pending NSSAI: NSSAI provided by the serving PLMN during a registration procedure, indicating the S-NSSAI(s) for which the network slice-specific authentication and authorization procedure is pending.
Requested NSSAI: NSSAI provided by the terminal device to the serving PLMN during registration.
Rejected NSSAI: NSSAI indicating S-NSSAI(s) which have been rejected for current PLMN or stand-alone non-public network (SNPN), for the current RA, for the failed or revoked network slice-specific authentication and authorization (NSSAA) and/or for the maximum number of terminal devices reached.
Subscribed S-NSSAI: S-NSSAI based on subscriber information, which a terminal device is subscribed to use in a PLMN.

A given distributed unit (DU) of a distributed access node (or a given non-distributed access node) may have a set of network slice access stratum (AS) group (NSAG) specific radio access channel (RACH) resources configured through operations, administration and management (OAM). The mapping of a network slice to a network slice AS group may be tracking area (TA)-specific. Moreover, each neighbor cell with a different TA may be configured with a different network slice to network slice AS group mapping. In a handover scenario, the terminal device should preferably be aware and take into account the network slice to network slice AS group mapping of the neighbor cell(s). However, the network slice to network slice AS group mapping is unknown to the target DU. This may cause issues with the configuration of the terminal device and the use of the RACH resources. The terminal device may not have the right slice group specific RACH resources during the time of handover which may lead to a service level agreement (SLA) violation or wrong RACH resource use.

To further clarify the technical problem at hand, a simple non-limiting example is provided in the following.

Let us assume that, in a handover scenario, a source cell is associated with the following network slice to network slice AS group mapping: {SG1, URLLC, TA1} & {SG2, eMBB, TA1}, where SG1 & SG2 are, respectively, service groups 1 & 2 and TA1 is a tracking area 1. Moreover, the target cell of the handover is associated with the following network slice to network slice AS group mapping: {SG2, URLLC, TA2} & {SG3, eMBB, TA2}, where SG3 is a service group 3 and TA2 is a tracking area 2. In other words, the terminal device in the source cell has currently (i.e., before handover) the mapping in TA1 and has allowed network slices relating to URLLC and eMBB while target DU has the mapping in TA2 and is not in random access (RA).

In a first exemplary handover scenario, the terminal device is assumed initially to have a protocol data unit (PDU) session on URLLC in the source cell. Then, the target DU allocates RACH resources for SG2 for the terminal device. On the other hand, the terminal device non-access stratum (NAS) indicates SG1 as RACH resource(s) to use for the terminal device. The terminal device determines that no RACH resources for the SG1 network slice AS group exist at the target cell. In such a case, the terminal device may, in some cases, still use the SG2 or alternatively throw an error.

In a second exemplary handover scenario, the terminal device is assumed initially to have a PDU session on URLLC and eMBB in the source cell. Then, the target DU allocates RACH resources for SG2 and SG3 for the terminal device. The terminal device non-access stratum (NAS) prioritizes eMBB and indicates SG2 as RACH resource(s) to use for the terminal device. The terminal device uses the SG2 RACH resource which it thinks is for eMBB in the target cell even though this configuration is, in actuality, for URLLC.

The embodiments to be discussed below in detail overcome, fully or at least in part, said deficiencies by enabling communication of the network slice to network slice AS group mapping of the terminal device during a handover procedure. Specifically, the embodiments may enable network slice/network slice AS group-specific RACH configuration within NG-RAN protocols over intra-RAN and cross-RAN interfaces.

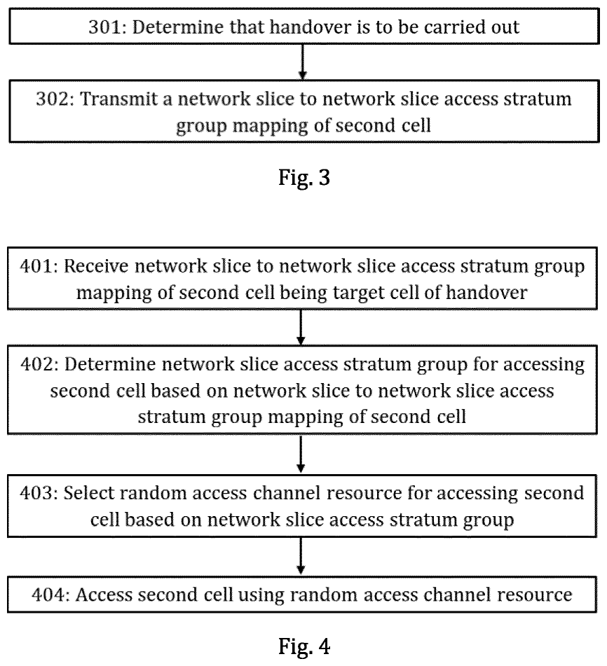

FIG. 3 illustrates a process according to embodiments for communicating network slice to network slice AS group mapping of a terminal device in a serving or source cell to a target access node or a target distributed unit as a part of a handover procedure. The handover procedure in question may be an inter-or intra-CU handover procedure for a distributed RAN architecture (or in some cases, an inter-access node handover procedure for a non-distributed RAN architecture, as will be described below after discussing FIG. 3 assuming a non-distributed RAN architecture). The illustrated process may be performed by a central unit of a distributed access node or specifically by a CU-CP entity of said central unit. Alternatively, the illustrated process may be performed by an apparatus for the central unit of the distributed access node or specifically for the CU-CP entity of said central unit. In other words, the apparatus in question may form a part of or be (communicatively) connected to the central unit or specifically of the CU-CP entity thereof. In the case of the inter-CU handover, the central unit may be assumed to be specifically a target central unit of the handover procedure. The central unit may correspond to a central unit 108 of FIG. 1 and/or the central unit 230 of FIG. 2. In the following, the actor of the process is called simply an apparatus for brevity.

Referring to FIG. 3, the apparatus determines, in block 301, that an inter-central unit or intra-central unit handover of the terminal device from a first cell provided by the first distributed unit to a second cell provided by a second distributed unit is to be carried out. The determination that the inter-central unit or intra-central unit handover is to be carried out in block 301 may be seen to imply that network slice-specific RACH configuration (or specifically beam failure recovery, BFR, network slice-specific RACH configuration) is needed by the terminal device. The first and second distributed units and the first and second cells may be equally called source and target distributed units and source and target cells, respectively.

If the handover in block 301 is an inter-CU handover, the first and second distributed units are assumed to be connected to first and second central units (the second central unit comprising the apparatus carrying out the process of FIG. 3 and being connected to the second distributed unit). Thus, the inter-CU handover involves a handover between first and second distributed access nodes. The first and second central units and the first and second distributed access node may be equally called source and target central units and source and target distributed access nodes, respectively.

On the other hand, if the handover in block 301 is an intra-CU handover, the first and second distributed units are assumed to be connected to the same central unit (being the central unit comprising the apparatus carrying out the process of FIG. 3). Thus, the intra-CU handover involves a handover between two distributed units of a single distributed access node.

The determination in block 301 may be based on a measurement report received from the terminal device via the first distributed unit (assuming that the process of FIG. 3 pertains to an intra-CU handover) or on a handover request received from the terminal device via the first distributed unit and the first central unit (assuming that the process of FIG. 3 pertains to an inter-CU handover).

The apparatus transmits, in block 302, a network slice to network slice AS group mapping of the second cell to the first distributed unit. The network slice to network slice AS group mapping may correspond, here and in the following, to mapping of one or more S-NSSAIs of one or more (respective) network slices to one or more network slice AS groups. In some embodiments, the network slice to network slice AS group mapping may also provide or comprise or be transmitted along with information on (relative) priority between the network slice AS group(s).

The transmission to the first distributed unit in block 302 may be carried out directly (i.e., not via any further central units), in the case of the intra-CU handover, or via the first central unit of the first distributed access node, in the case of the inter-CU unit handover. In the former case (intra-CU handover), the network slice to network slice AS group mapping may be transmitted to the first distributed unit as a part of or along with a context modification request of the terminal device. In the latter case (inter-CU handover), the network slice to network slice access stratum group mapping may be transmitted to the first central unit as a part of or along with a handover request acknowledgment. The first central unit of the first distributed access node may, subsequently, transmit the network slice to network slice access stratum group mapping of the second cell further to the first distributed unit, for example, comprised in a context medication request of the terminal device. In either case, the network slice to network slice access stratum group mapping of the second cell may eventually be communicated to the terminal device.

In some embodiments, the apparatus may further determine, after block 301 and before moving on to block 302, whether or not the first and second cells are configured with different network slice to network slice access stratum group mappings or at least with potentially different network slice to network slice access stratum group mappings, as will be described below in detail. The transmission of block 302 may be carried out only in response to the first and second cells being configured with different network slice to network slice access stratum group mappings or at least with potentially different network slice to network slice access stratum group mappings. This provides the benefit that redundant transmissions are avoided or at least minimized.

In some embodiments, the process of FIG. 3 may be applied to a non-distributed RAN architecture. The discussed provided applies, mutatis mutandis, also in this case. Namely, in such embodiments, the process may be carried out by an access node or an apparatus for said access node, where the access node corresponds to a target (or second) access node of the handover procedure and provides the second cell. Moreover, the access node may transmit, in block 302, the network slice to network slice AS group mapping of the second cell to the source or serving (or first) access node (which transmits the network slice to network slice AS group mapping of the second cell further to the terminal device).

In other words, in such non-distributed RAN-based embodiments, an apparatus (for a second access node) determines, in block 301, that a handover of a terminal device from a first cell provided by a first access node to a second cell provided by the second access node is to be carried out and transmits, in block 302, a network slice to network slice access stratum group mapping of the second cell to the first access node.

FIG. 4 illustrates a process according to embodiments for receiving and taking into account network slice to network slice AS group mapping of a target cell in RACH resource allocation of a handover procedure. The illustrated process may be carried out following the execution of the process of FIG. 3. The illustrated process may be performed by a terminal device or a part thereof or connected thereto (i.e., an apparatus for the terminal device). The terminal device may correspond to any terminal device 100, 102 of FIG. 1 and/or any terminal device 221, 222, 223 of FIG. 2. In the following, the actor of the process is called simply an apparatus for brevity.

Referring to FIG. 4, the apparatus receives, in block 401, from a first radio access network (RAN) node, a network slice to network slice access stratum group mapping of a second cell being a target cell of a handover. Here, the second cell is assumed to be provided by a second RAN node. Similar to as described in connection with FIG. 3, the handover may be an intra-CU or inter-CU handover from a first cell to a second cell. Alternatively, the handover may be a handover between non-distributed access nodes (or between one distributed access node and one non-distributed access node).

The first and second RAN nodes as discussed in the previous paragraph may be defined as follows. The first RAN node may be a first (non-distributed) access node or a first distributed unit of a first distributed access node. Moreover, the second RAN node may be a second (non-distributed) access node, a second distributed unit of the first distributed access node or of a second distributed access node.

In some embodiments, the apparatus may receive, in block 401, the network slice to network slice access stratum group mapping of the second cell as a part of or along with an RRC reconfiguration message. The RRC reconfiguration message may (further) comprise a handover command for carrying out the handover from the first cell to the second cell. The RRC reconfiguration message may also comprise one or more reserved or allocated RACH resources for the terminal device (defined using a context step procedure carried out between a central unit and a target distributed unit).

The apparatus determines, in block 402, a network slice AS group for accessing the second cell based on the network slice to network slice AS group mapping of the second cell.

The apparatus selects (or allocates), in block 403, a (network slice AS group-specific) RACH resource for accessing the second cell based at least on the network slice AS group. In some embodiments, a plurality of RACH resources may be selected in block 403.

Subsequently, the apparatus accesses, in block 404, the second cell using said RACH resource(s).

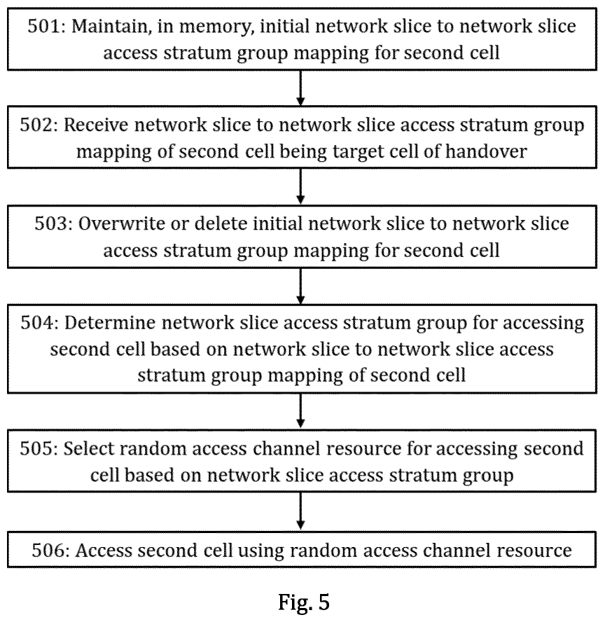

FIG. 5 illustrates another process according to embodiments for receiving and taking into account a network slice to network slice AS group mapping of a target cell in RACH resource selection of a handover procedure. The illustrated process may be carried out following the execution of the process of FIG. 3. The illustrated process may be performed by a terminal device or a part thereof or connected thereto (i.e., an apparatus for a terminal device). The terminal device may correspond to any terminal device 100, 102 of FIG. 1 and/or any terminal device 221, 222, 223 of FIG. 2. In the following, the actor of the process is called simply an apparatus for brevity.

The process of FIG. 5 may correspond, to a large extent, to the process of FIG. 4. Namely, blocks 502, 504, 505, 506 of FIG. 5 may correspond, mutatis mutandis, to blocks 401 to 404, respectively, and are thus not discussed in the following in detail for brevity.

Referring to FIG. 5, it is initially assumed that the apparatus maintains, in block 501, in at least one memory, an initial network slice to network slice AS group mapping for initial access or re-establishment to the second cell (e.g., an RA procedure during initial access). Said initial network slice to network slice access stratum group mapping may have been received, e.g., as a part of an RRC reconfiguration message, during a previous handover involving the second cell. Alternatively, the initial network slice to network slice AS group mapping may have been received via the NAS.

In response to receiving (new) network slice to network slice AS group mapping of the second cell in block 502, the apparatus performs, in block 503, one of two possible actions. According to the first option, the apparatus overwrites, in block 503, the initial network slice to network slice AS group mapping with the network slice to network slice AS group mapping in the at least one memory. According to the second option, the apparatus deletes (or discards or removes), in block 503, the initial network slice to network slice AS group mapping (and optionally stores the received network slice to network slice AS group mapping to the at least one memory).

Thereafter, the process proceeds as described above in connection with FIG. 4, that is, the apparatus determines, in block 504, a network slice AS group for accessing the second cell based on the (newly received) network slice to network slice AS group mapping of the second cell, selects, in block 505, RACH resource(s) for accessing the second cell based on the network slice AS group and accesses, in block 506, the second cell using the RACH resource(s).

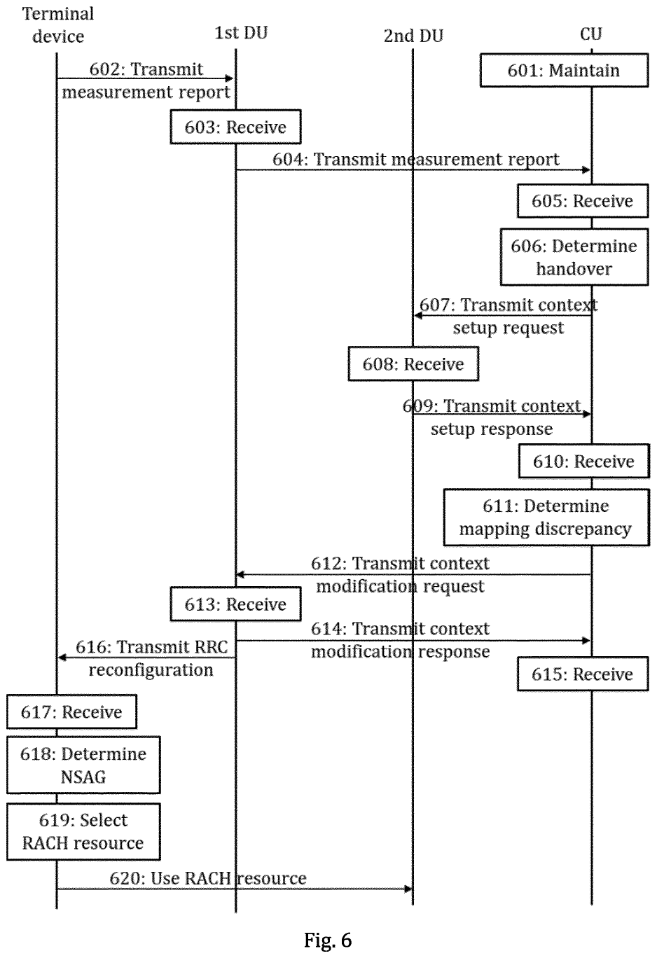

FIG. 6 illustrates processes according to embodiments for, as a part of an intra-CU handover procedure, communicating, when deemed necessary or at least beneficial, network slice to network slice AS group mapping of a target cell (called here a second cell) to a terminal device via a source distributed unit (called here a first distributed unit) and selection of RACH resource(s) based on said network slice to network slice AS group mapping. Specifically, FIG. 6 illustrates signaling between a terminal device, a first distributed unit of a distributed access node, a second distributed unit of the distributed access node and a central unit of the distributed access node (or specifically the CU-CP entity thereof). From the point of view of the handover procedure, the first distributed unit may be called a source (or serving) distributed unit and the second distributed unit may be called a target distributed unit. The terminal device may correspond to any of the terminal devices 100, 102 of FIG. 1 and/or any of the terminal devices 221, 222, 223 of FIG. 2. The first and second distributed units may correspond to the distributed unit 104 of FIG. 1 and/or the distributed unit 220 of FIG. 2. The central unit may correspond to the central unit 108 of FIG. 1 and/or the central unit 230 of FIG. 2.

Referring to FIG. 6, it may be initially assumed, in block 601, that the central unit (or the CU-CP) is aware of a network slice to network slice AS group mapping of the terminal device in a first cell (i.e., the serving cell) provided by the first distributed unit. In other words, the central unit may maintain, in block 601, in at least one memory, the network slice to network slice AS group mapping of the terminal device in the first cell. The first distributed unit may have previously transmitted the network slice to network slice AS group mapping of the terminal device in the first cell to the central unit.

The handover procedure may be initiated by the terminal device transmitting, in message 602, a measurement report to the first distributed unit. Upon receiving the measurement report in block 603, the first distributed unit further transmits, in message 604, the measurement report to the central unit. The central unit receives, in block 605, the measurement report.

Based at least on the measurement report, the central unit determines, in block 606, that a handover from the first cell to a second cell provided by the second distributed unit should be carried out for the terminal device and thus a network slice-specific RACH configuration (i.e., selection of a network slice or network slice AS group-specific RACH resource) for the terminal device is needed. The first and second cells may be neighboring cells.

The central unit transmits, in message 607, a context setup request associated with a terminal device context of the terminal device to the second distributed unit. The context setup request comprises information on one or more network slice-specific data radio bearers (DRBs) to be provided for the terminal device (e.g., DRB1 for network slice 1 and DRB2 for network slice 2). The context setup request may be a UE Context Setup Request.

Upon receiving the context setup request in block 608, the second distributed unit transmits, in message 609, a context setup response to the central unit. The context setup response comprises information on one or more network slice AS group-specific RACH configurations for one or more network slices associated with the terminal device (e.g., RACH configuration of network slice AS group 1 for network slice 1 and RACH configuration of network slice AS group 2 for network slice 2). The context setup response may be a UE Context Setup Response. In other words, the second distributed unit may configure or reserve or allocate one or more RACH resources (e.g., a preamble and/or time/frequency information) for the handover based on the context setup request and transmit, in message 609, this information comprised in the context setup response back to the central unit.

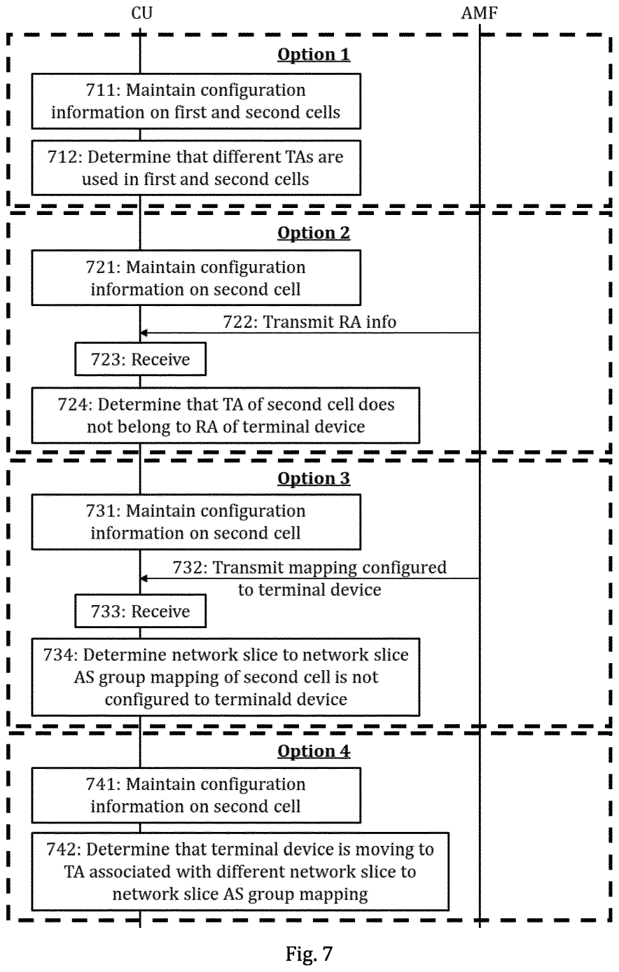

Upon receiving the context setup response in block 610, the central unit determines, in block 611, that the first and second cells are configured with different network slice to network slice AS group mappings or, in some cases, at least with potentially different network slice to network slice access stratum group mappings. Potentially different network slice to network slice AS group mapping may mean here that there is an increased likelihood (but it is not certain) that the first and second cells employ different network slice to network slice AS group mappings. The determination in block 611 may be based, for example, on tracking areas of the first and second distributed units. Four alternative detailed implementations of block 611 are discussed in detail below in connection with FIG. 7.

If it is determined that the first and second cells are not configured with different network slice to network slice AS group mappings or, in some cases, not even potentially different network slice to network slice AS group mappings (not shown in FIG. 6), the intra-CU handover procedure may be carried out to completion in a conventional manner (without communicating the network slice to network slice AS group of the second cell to the terminal device).

The central unit transmits, in message 612, a context modification request (or a terminal device context modification request) associated with a terminal device context of the terminal device to the first distributed unit. The (terminal device) context modification request comprises an RRC message comprising a handover command. The network slice to network slice AS group mapping of the second cell is comprised in the context modification request as a part of the RRC message or as a separate information element. The context modification request may be a UE Context Modification Request message.

Upon receiving the context modification request in block 613, the first distributed unit transmits, in message 614, a context modification response to the central unit. The context modification response serves to acknowledge the successful reception of the context modification request. The context modification response may be a UE Context Modification Complete message. The central unit receives, in block 615, the context modification response.

The first distributed unit further transmits, in message 616, an RRC reconfiguration message to the terminal device. The RRC reconfiguration message comprises the handover command and the network slice to network slice AS mapping of the second cell. The RRC reconfiguration message may comprise also the one or more reserved or allocated RACH resources. The RRC reconfiguration message may be an “RRCReconfiguration” message.

In some alternative embodiments, message 616 may be transmitted before message 614.

In some alternative embodiments, the RRC reconfiguration message 616 may comprise the handover command but not the network slice to network slice AS group mapping of the second cell. In such embodiments, the network slice to network slice AS group mapping of the second cell may be transmitted from the first distributed unit to the terminal device separately from the RRC reconfiguration message (e.g., as a separate RRC message).

The actions relating to elements 617 to 620 may correspond fully to actions described previous in connection with blocks 401 to 404 of FIG. 4 and are thus not repeated here for brevity. In some embodiments, one or more of the additional features discussed in connection with FIG. 5 may also be implemented here.

FIG. 7 illustrates processes according to embodiments for determining whether there exists a discrepancy between the network slice to network slice AS group mappings of first and second cells (i.e., source and target cells) involved in a handover procedure. Specifically, FIG. 7 illustrates four alternative procedures for carrying out block 611 of FIG. 6. FIG. 7 illustrates signaling between a central unit of a distributed access node (or specifically the CU-CP entity thereof) and an AMF entity of a core network. The central unit may correspond to the central unit 108 of FIG. 1 and/or the central unit 230 of FIG. 2. The AMF may form a part of the core network 110 of FIG. 1.

According to the first option, the central unit is assumed to initially maintain, in block 711, in at least one memory, configuration information at least on the first and second cells (i.e., the cells involved in the handover). Specifically, the configuration information comprises at least information on tracking areas of the first and second cells.

The central unit determines, in block 712, that the first and second cells are under different tracking areas based on the configuration information. Based on this determination, the central unit may determine that the network slice to network slice AS group mapping of the second cell should be communicated to the terminal device (as described above in connection with elements 612 to 617 of FIG. 6).

It should be noted that the fact that the first and second cells are under different tracking areas does not necessarily imply that the network slice to network slice AS group mappings associated with the first and second cells are different. However, since the mapping of network slice(s) to network slice AS group(s) may be tracking area-specific, it is possible or even likely that that the network slice to network slice AS group mappings associated with the first and second cells are different.

According to the second option, the central unit is assumed to initially maintain, in block 721, in at least one memory, configuration information at least on the second cell (i.e., the target cell). Specifically, the configuration information comprises at least information on a tracking area of the second cell. Optionally, configuration information on the first cell may also be maintained in the at least one memory.

The AMF transmits, in message 722, information on a registration area of the terminal device to the central unit. The central unit receives, in block 723, the information on the registration area of the terminal device.

Then, the central unit determines, in block 724, that the tracking area of the second cell does not belong to the registration area of the terminal device. Based on this determination, the central unit may determine that the network slice to network slice AS group mapping of the second cell should be communicated to the terminal device (as described above in connection with elements 612 to 617 of FIG. 6).

According to the third option, the central unit is assumed to initially maintain, in block 731, in at least one memory, configuration information on the second cell. Specifically, the configuration information comprises at least information on a network slice to network slice AS group mapping of the second cell.

The AMF transmits, in message 732, one or more network slice to network slice AS group mappings for one or more tracking areas within a registration area of the terminal device, respectively. As the one or more network slice to network slice AS group mappings relate to the one or more tracking areas within the registration area of the terminal device, they may be assumed to be configured to the terminal device. The central unit receives, in block 733, the one or more network slice to network slice as group mappings.

The central unit determines, in block 734, based on the configuration information and the one or more network slice to network slice AS group mappings (or at least one of them) that a current network slice to network slice AS group mapping of the terminal device differs from a network slice to network slice AS group mapping of the second cell. The current network slice to network slice AS group mapping of the terminal device is assumed to be comprised in the one or more network slice to network slice AS group mappings received in block 733. Based on this determination, the central unit may determine that the network slice to network slice AS group mapping of the second cell should be communicated to the terminal device (as described above in connection with elements 612 to 617 of FIG. 6).

According to the fourth option, the central unit is assumed to initially maintain, in block 741, in at least one memory, configuration information on the first and second cells. Specifically, the configuration information comprises at least information on a network slice to network slice AS group mappings of the first and second cells.

The central unit determines, in block 742, that the network slice to network slice AS group mapping of the first cell differs from the network slice to network slice AS group mapping of the second cell.

In some embodiments, one or more of the four options discussed in connection with FIG. 7 may be combined.

In some embodiments, at least some of the messages 722, 732 may be transmitted by a core network node or entity other than the AMF.

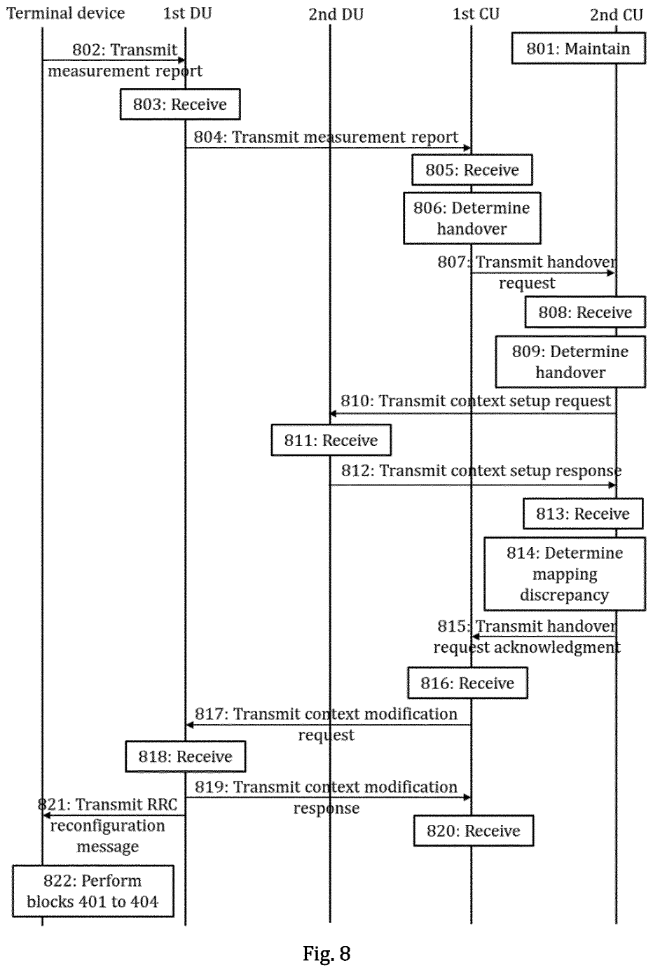

FIG. 8 illustrates processes according to embodiments for, as a part of an inter-CU handover procedure, communicating, when needed necessary or at least beneficial, network slice to network slice AS group mapping of a target cell (called here a second cell) to a terminal device via a source distributed unit (called here a first distributed unit) and selecting a RACH resource based on said network slice to network slice AS group mapping. Specifically, FIG. 8 illustrates signaling between a terminal device, a first distributed unit of a first distributed access node, a second distributed unit of a second distributed access node, a first central unit of the first distributed access node (or specifically the CU-CP entity thereof) and a second central unit of the second distributed access node (or specifically the CU-CP entity thereof). From the point of view of the handover procedure, the first distributed unit may be called a source (or serving) distributed unit and the second distributed unit may be called a target distributed unit. The terminal device may correspond to any of the terminal devices 100, 102 of FIG. 1 and/or any of the terminal devices 221, 222, 223 of FIG. 2. The first and second distributed units may correspond to the distributed unit 104 of FIG. 1 and/or the distributed unit 220 of FIG. 2. The first and second central units may correspond to the central unit 108 of FIG. 1 and/or the central unit 230 of FIG. 2.

Referring to FIG. 8, it may be initially assumed, in block 801, that the second central unit (or the CU-CP) is aware of a network slice to network slice AS group mapping of the terminal device in a first cell (i.e., the serving cell) provided by the first distributed unit. In other words, the second central unit may maintain, in block 801, in at least one memory, the network slice to network slice AS group mapping of the terminal device in the first cell (i.e., the network slice to network slice AS group mapping of the first cell). The first central unit may have previously transmitted the network slice to network slice AS group mapping of the terminal device in the first cell to the second central unit.

The handover procedure may be initiated by the terminal device transmitting, in message 802, a measurement report to the first distributed unit. Upon receiving the measurement report in block 803, the distributed unit further transmits, in message 804, the measurement report to the first central unit. The transmission of message 804 may correspond to uplink RRC message transfer.

Upon receiving the measurement report in block 805, the first central unit determines, in block 806, that an inter-CU handover from the first cell provided by the first distributed unit of the first distributed access node to the second cell provided by the second distributed unit of the second distributed access node should be carried out for the terminal device, where the first and second cells may be neighboring cells. Consequently, the first central unit transmits, in message 807, a handover request to the second central unit of the second distributed access node.

The second central unit receives, in block 808, the handover request from the first central unit. Based on the handover request, the second central unit determines, in block 809, that the inter-CU handover from the first cell to the second cell is to be carried out for the terminal device and thus a network slice-specific RACH configuration for the terminal device is needed.

The second central unit and the second distributed unit carry out the (terminal device) context setup process in elements 810 to 813 in a similar (or same) manner as described previously in connection with elements 607 to 610 of FIG. 6 for the central unit and the second distributed unit.

The second central unit determines, in block 814, that the first and second cells are configured with different network slice to network slice AS group mappings or, in some cases, at least with potentially different network slice to network slice access stratum group mappings. This determination may be carried out similar to as described above for the intra-CU handover scenario in connection with FIGS. 6 and/or 7. Specifically, the options 1, 2 and 3 of FIG. 7 are applicable, mutatis mutandis, also to this inter-CU handover scenario. However, it should be noted regarding option 2 of FIG. 7 that the information on the registration area of the terminal device may be transmitted to the second central unit, in this case, by the first central unit, for example, in the handover request or a separate or dedicated message, as opposed to it being transmitted by the AMF directly to the second central unit. The first central unit may have received the information on the registration area of the terminal device previously from the AMF, similar as described in connection with message 722 of FIG. 7.

If it is determined that the first and second cells are not configured with different network slice to network slice access stratum group mappings or, in some cases, not even potentially different network slice to network slice access stratum group mappings (not shown in FIG. 8), the inter-CU handover procedure may be carried out to completion in a conventional manner (without communicating the network slice to network slice AS group of the second cell to the terminal device).

In response to or following the determination in block 814, the second central unit transmits, in message 815, a handover request acknowledgment to the first central unit. The handover request acknowledgment comprises at least the network slice to network slice AS group mapping of the second cell or an RRC message comprising the network slice to network slice AS group mapping of the second cell. The first central unit receives, in block 816, the handover request acknowledgment.

The first central unit and the first distributed unit carry out the (terminal device) context modification process in elements 817 to 820 in a similar (or same) manner as described previously in connection with elements 612 to 615 of FIG. 6 for the central unit and the first distributed unit.

The first distributed unit further transmits, in message 821, an RRC reconfiguration message to the terminal device. The RRC reconfiguration message comprises the handover command and the network slice to network slice access stratum group mapping of the second cell. The RRC reconfiguration message may comprise also one or more reserved or allocated RACH resources for the terminal device determined using the context setup procedure.

In some alternative embodiments, message 821 may be transmitted before message 819.

In some alternative embodiments, the RRC reconfiguration message 821 may comprise the handover command but not the network slice to network slice AS group mapping of the second cell. In such embodiments, the network slice to network slice AS group mapping of the second cell may be transmitted from the first distributed unit to the terminal device separately from the RRC reconfiguration message (e.g., as a separate RRC message).

The actions relating to element 822 may correspond fully to actions described previously in connection with blocks 401 to 404 of FIG. 4 (and/or illustrated with elements 617 to 620 of FIG. 6) and are thus not repeated here for brevity. In some embodiments, one or more of the additional features discussed in connection with FIG. 5 may also be implemented here.

While FIG. 8 illustrates an inter-CU handover-based embodiment where the first and second access nodes are distributed access nodes, in other embodiments, the first and/or second access nodes may be non-distributed access nodes. In such embodiments, elements 804, 805, 810 to 813, 817 to 820 (relating to DU-CU communication) may be omitted and thus only actions relating to elements 803, 806, 807, 816, 821 may be carried out by the first non-distributed access node and only actions relating to elements 801, 808, 809, 814, 815 may be carried out by the second non-distributed access node.

The embodiments discussed above provide at least the following advantages:
Network is enabled to configure the terminal device with network slice-specific RACH resources in the non-disaggregated or disaggregated architecture.
The RACH configuration may be taken into account for handover decisions at RAN nodes for guaranteeing user SLAs through network slice-specific RACH configuration awareness.

The blocks, related functions, and information exchanges (messages) described above by means of FIGS. 3 to 8 in no absolute chronological order, and some of them may be performed simultaneously or in an order differing from the given one. Other functions can also be executed between them or within them, and other information may be sent, and/or other rules applied. Some of the blocks or part of the blocks or one or more pieces of information can also be left out or replaced by a corresponding block or part of the block or one or more pieces of information.

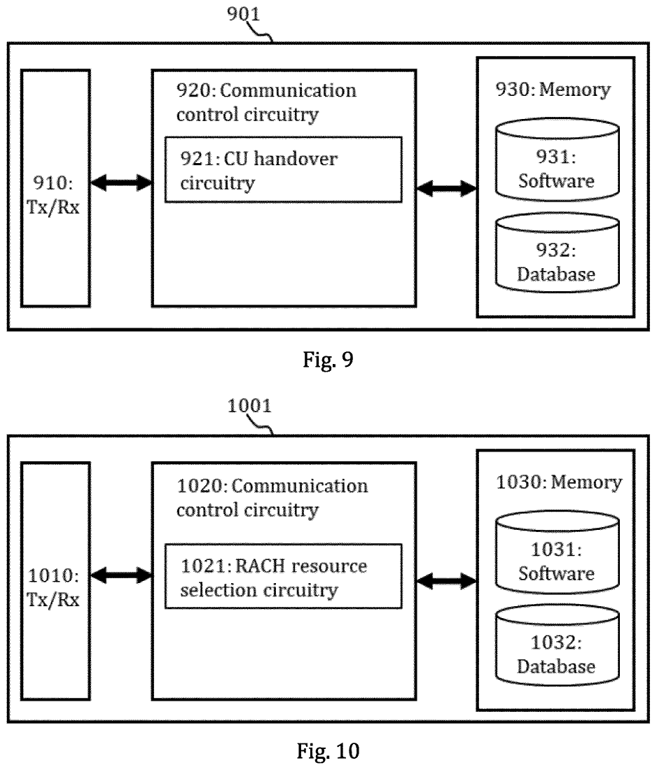

FIG. 9 provides an apparatus 901 for a central unit (CU) of a distributed access node (e.g., a distributed gNB) according to some embodiments. Specifically, FIG. 9 may illustrate an apparatus for a central unit configured to carry out at least the functions described above in connection with communication of a network slice to network slice AS group mapping during an intra-CU or inter-CU handover. The apparatus 901 may be a central unit or a CU-CP entity of the central unit or form a part of a central unit or of a CU-CP entity thereof. The central unit in question may be the central unit 108 of FIG. 1, the central unit 230 of FIG. 2 and/or any central unit (including first and/or second CUs) of any of FIGS. 3 to 5. The central unit may comprise a control plane entity (CU-CP) and a user plane entity (CU-UP). The actions of the central unit as described in connection with embodiments may be carried out, fully or predominantly, by the control plane entity.

The apparatus 901 may comprise one or more control circuitry 920, such as at least one processor, and at least one memory 930, including one or more algorithms 931, such as a computer program code (software) wherein the at least one memory and the computer program code (software) are configured, with the at least one processor, to cause the apparatus 901 to carry out any one of the exemplified functionalities of the central unit (or the CU-CP or an apparatus for a central unit) described above. Said at least one memory 930 may also comprise at least one database 932.

Referring to FIG. 9, the one or more communication control circuitry 920 of the apparatus 901 comprise at least CU handover circuitry 921 which is configured to perform a handover related functionalities comprising communication of a network slice to network slice AS group mapping (of a target cell). To this end, the CU handover circuitry 921 of the apparatus 901 is configured to carry out at least some of the functionalities of the central unit (or the CU-CP or an apparatus for a central unit) described above, e.g., by means of any of elements 301, 302 of FIG. 3, elements 601, 605 to 607, 610 to 612, 615 of FIG. 6, elements 711, 712, 721, 723, 724, 731, 733, 734, 741, 742 of FIG. 7 and/or elements 801, 805 to 810, 813 to 817, 820 of FIG. 8 using one or more individual circuitries.

Referring to FIG. 9, the apparatus 901 may further comprise different interfaces 910 such as one or more communication interfaces (TX/RX) comprising hardware and/or software for realizing communication connectivity according to one or more communication protocols. Specifically, the one or more communication interfaces 910 may comprise, for example, interfaces providing a connection to the Internet and a core network of a wireless communications network (e.g., to the AMF therein). The one or more communication interface 910 may provide the apparatus 901 (and thus the central unit) with communication capabilities to communicate in a cellular communication system and enable communication with user devices (terminal devices) and different network nodes or elements and/or a communication interface to enable communication between different network nodes or elements (e.g., one or more distributed units), for example. The one or more communication interfaces 910 may comprise, for example, one or more F1 interfaces (e.g., one or more FI-U and/or F1-C interfaces), one or more Xn interfaces and one or more NG interfaces.

FIG. 10 provides an apparatus 1001 for a terminal device according to some embodiments. Specifically, FIG. 10 may illustrate an apparatus 1001 for a terminal device configured to carry out at least the functions described above in connection with taking a network slice or network slice AS group mapping of a target cell into account in selection of RACH resources in connection with a handover. The apparatus 1001 may be a terminal device or form a part of a terminal device. The terminal device in question may be any of the terminal devices 100, 102 of FIG. 1 and/or any of the terminal devices 221 to 223 of FIG. 2.

The apparatus 1001 may comprise one or more control circuitry 1020, such as at least one processor, and at least one memory 1030, including one or more algorithms 1031, such as a computer program code (software) wherein the at least one memory and the computer program code (software) are configured, with the at least one processor, to cause the apparatus 1001 to carry out any one of the exemplified functionalities of the terminal device (and apparatus for the terminal device) described above. Said at least one memory 1030 may also comprise at least one database 1032.

Referring to FIG. 10, the one or more communication control circuitry 1020 of the apparatus 1001 comprise at least RACH resource selection circuitry 1021 for selection of RACH resources in connection with a handover. To this end, the RACH resource selection circuitry 1021 of the apparatus 1001 is configured to carry out at least some of the functionalities of the terminal device (or the apparatus for the terminal device) described above, e.g., by means of any of elements 401 to 404 of FIG. 4, elements 501 to 506, elements 602, 617 to 620 of FIG. 6 and/or elements 802, 822 of FIG. 8, using one or more individual circuitries.

Referring to FIG. 10, the apparatus 1001 may further comprise different interfaces 1010 such as one or more communication interfaces (TX/RX) comprising hardware and/or software for realizing communication connectivity according to one or more communication protocols. Specifically, the one or more communication interfaces 1010 may comprise, for example, interfaces providing a connection to the Internet and a core network of a wireless communications network (via one or more distributed and/or non-distributed access nodes). The one or more communication interface 1010 may provide the apparatus 1001 (and thus the terminal device) with communication capabilities to communicate in a cellular communication system and enable communication between user devices (terminal devices) and with different network nodes or elements (e.g., one or more distributed and/or non-distributed access nodes).

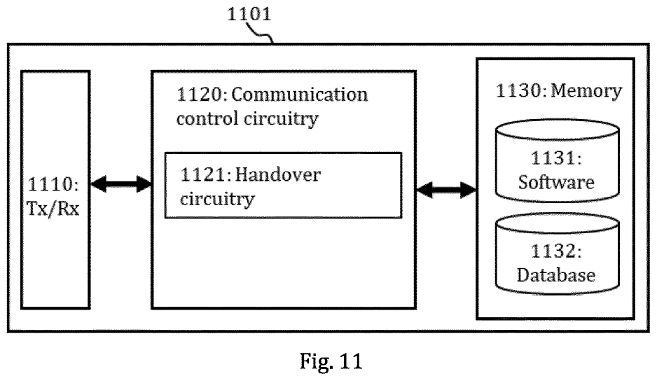

FIG. 11 provides an apparatus 1101 for a (non-distributed or monolithic) access node (e.g., a non-distributed or monolithic gNB) according to some embodiments. Specifically, FIG. 11 may illustrate an apparatus for an access node configured to carry out at least the functions described above in connection with communication of a network slice to network slice AS group mapping during a handover. The apparatus 1101 may be an access node or form a part of an access node. The access node unit in question may be the access node 104 of FIG. 1.

The apparatus 1101 may comprise one or more control circuitry 1120, such as at least one processor, and at least one memory 1130, including one or more algorithms 1131, such as a computer program code (software) wherein the at least one memory and the computer program code (software) are configured, with the at least one processor, to cause the apparatus 1101 to carry out any one of the exemplified functionalities of the (non-distributed) access node described above. Said at least one memory 1130 may also comprise at least one database 1132.

Referring to FIG. 11, the one or more communication control circuitry 1120 of the apparatus 1101 comprise at least handover circuitry 1121 which is configured to carry out at least some of the functionalities described above, e.g., by means of any of element 301 to 302 of FIG. 3, blocks 711, 712, 721, 723, 724, 731, 733, 734, 741, 742 of FIG. 7 and/or elements 801, 803, 806, 807, 808, 809, 814, 815, 816, 821, using one or more individual circuitries.

Referring to FIG. 11, the apparatus 1101 may further comprise different interfaces 1110 such as one or more communication interfaces (TX/RX) comprising hardware and/or software for realizing communication connectivity according to one or more communication protocols. Specifically, the one or more communication interfaces 1110 may comprise, for example, interfaces providing a connection to the Internet and a core network of a wireless communications network. The one or more communication interface 1110 may provide the apparatus (and thus the access node) with communication capabilities to communicate in a cellular communication system and enable communication between user devices (terminal devices) and different network nodes or elements (e.g., other access nodes) and/or a communication interface to enable communication between different network nodes or elements, for example.

Referring to any of FIGS. 9 to 11, the memories 930, 1030, 1130 may be implemented using any suitable data storage technology, such as semiconductor based memory devices, flash memory, magnetic memory devices and systems, optical memory devices and systems, fixed memory and removable memory. Additionally or alternatively, the one or more communication interfaces 910, 1030, 1130 of any of FIGS. 9 to 11 may comprise standard well-known components such as an amplifier, filter, frequency-converter, (de)modulator, and encoder/decoder circuitries, controlled by the corresponding controlling units, and one or more antennas.

As used in this application, the term ‘circuitry’ may refer to one or more or all of the following: (a) hardware-only circuit implementations, such as implementations in only analog and/or digital circuitry, and (b) combinations of hardware circuits and software (and/or firmware), such as (as applicable): (i) a combination of analog and/or digital hardware circuit(s) with software/firmware and (ii) any portions of hardware processor(s) with software, including digital signal processor(s), software, and memory(ies) that work together to cause an apparatus, such as a terminal device or an access node, to perform various functions, and (c) hardware circuit(s) and processor(s), such as a microprocessor(s) or a portion of a microprocessor(s), that requires software (e.g. firmware) for operation, but the software may not be present when it is not needed for operation. This definition of ‘circuitry’ applies to all uses of this term in this application, including any claims. As a further example, as used in this application, the term ‘circuitry’ also covers an implementation of merely a hardware circuit or processor (or multiple processors) or a portion of a hardware circuit or processor and its (or their) accompanying software and/or firmware. The term ‘circuitry’ also covers, for example and if applicable to the particular claim element, a baseband integrated circuit for an access node or a terminal device or other computing or network device.

In an embodiment, at least some of the processes described in connection with FIGS. 3 to 8 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, or circuitry. In an embodiment, the at least one processor, the memory, and the computer program code form processing means or comprises one or more computer program code portions for carrying out one or more operations according to any one of the embodiments of FIGS. 3 to 8 or operations thereof.

According to an aspect, there is provided an apparatus (e.g., a terminal device or a part thereof) comprising means for performing:
receiving from a first radio access network node, a network slice to network slice access stratum group mapping of a second cell being a target cell of a handover, wherein the second cell is provided by a second radio access network node;
determining a network slice access stratum group for accessing the second cell based on the network slice to network slice access stratum group mapping of the second cell;
selecting a random access channel resource for accessing the second cell based on the network slice access stratum group; and
accessing the second cell using the random access channel resource.

According to an aspect, there is provided an apparatus (e.g., a central unit of a distributed access node or a part thereof) comprising means for performing:
determining that an inter-central unit or intra-central unit handover of a terminal device from a first cell provided by a first distributed unit to a second cell provided by a second distributed unit is to be carried out; and
transmitting a network slice to network slice access stratum group mapping of the second cell to the first distributed unit directly, in a case of the intra-central unit handover, or to the first distributed unit via a first central unit, in a case of the inter-central unit handover.

According to an aspect, there is provided an apparatus (e.g., an access node or a part thereof) comprising means for performing:
determining that a handover of a terminal device from a first cell provided by a first access node to a second cell provided by a second access node is to be carried out; and
transmitting a network slice to network slice access stratum group mapping of the second cell to the first access node.

Embodiments as described may also be carried out in the form of a computer process defined by a computer program or portions thereof. Embodiments of the methods described in connection with FIGS. 3 to 8 may be carried out by executing at least one portion of a computer program comprising corresponding instructions. The computer program may be provided as a computer readable medium comprising program instructions stored thereon or as a non-transitory computer readable medium comprising program instructions stored thereon. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the embodiments have been described above with reference to examples according to the accompanying drawings, it is clear that the embodiments are not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising:
at least one processor; and
at least one memory including computer program code;
the at least one memory and the computer program code being configured, with the at least one processor, to cause the apparatus at least to perform:
receiving, from a first radio access network node, a network slice to network slice access stratum group mapping of a second cell being a target cell of a handover, wherein the second cell is provided by a second radio access network node;
determining a network slice access stratum group for accessing the second cell based on the network slice to network slice access stratum group mapping of the second cell;
selecting a random access channel resource for accessing the second cell based on the network slice access stratum group; and
accessing the second cell using the random access channel resource.

2. The apparatus according to claim 1, wherein
the first radio access network node is a first access node or a first distributed unit of a first distributed access node and/or
the second radio access network node is a second access node or a second distributed unit of the first distributed access node or of a second distributed access node.

3. The apparatus according to claim 1, wherein the at least one memory and the computer program code are configured, with the at least one processor, to cause the apparatus to perform the receiving of the network slice to network slice access stratum group mapping of the second cell by:
receiving a radio resource control reconfiguration message comprising a handover command and the network slice to network slice access stratum group mapping of the second cell.

4. The apparatus according to claim 1, wherein the at least one memory and the computer program code are configured, with the at least one processor, to cause the apparatus to further perform:
maintaining, in the at least one memory, before the receiving, an initial network slice to network slice access stratum group mapping for initial access or re-establishment to the second cell; and
overwriting, in response to the receiving of the network slice to network slice access stratum group mapping, the initial network slice to network slice access stratum group mapping with the network slice to network slice access stratum group mapping; or
deleting, in response to the receiving of the network slice to network slice access stratum group mapping, the initial network slice to network slice access stratum group mapping.

5. An apparatus comprising:
at least one processor; and
at least one memory including computer program code;
the at least one memory and the computer program code being configured, with the at least one processor, to cause the apparatus at least to perform:
determining that an inter-central unit or intra-central unit handover of a terminal device from a first cell provided by a first distributed unit to a second cell provided by a second distributed unit is to be carried out; and
transmitting a network slice to network slice access stratum group mapping of the second cell to the first distributed unit directly, in a case of the intra-central unit handover, or to the first distributed unit via a first central unit, in a case of the inter-central unit handover.

6. The apparatus according to claim 5, wherein the first and second distributed units are distributed units of a first distributed access node and thus the intra-central unit handover is determined to be carried out and the at least one memory and the computer program code are configured, with the at least one processor, to cause the apparatus to perform the transmitting of the network slice to network slice access stratum group mapping of the second cell by at least:
transmitting a context modification request associated with a terminal device context of the terminal device to the first distributed unit, wherein the terminal device context modification request comprises a radio resource control message comprising a handover command, the network slice to network slice access stratum group mapping of the second cell being comprised in the context modification request as a part of the radio resource control message or as a separate information element.

7. The apparatus according to claim 5, wherein the first and second distributed units are, respectively, distributed units of first and second distributed access nodes and thus the inter-central unit handover is determined to be carried out, the first central unit is a central unit of the first distributed access node and the at least one memory and the computer program code are configured, with the at least one processor, to cause the apparatus to:
perform the determining that the inter-central unit handover is to be carried out by at least receiving a handover request for the inter-central unit handover from the first central unit; and
perform the transmitting of the network slice to network slice access stratum group mapping of the second cell by at least transmitting a handover request acknowledgment to the first central unit, wherein the handover request acknowledgment comprises the network slice to network slice access stratum group mapping of the second cell.

8. An apparatus comprising:
at least one processor; and
at least one memory including computer program code;
the at least one memory and the computer program code being configured, with the at least one processor, to cause the apparatus at least to perform:
determining that a handover of a terminal device from a first cell provided by a first access node to a second cell provided by a second access node is to be carried out; and
transmitting a network slice to network slice access stratum group mapping of the second cell to the first access node.

9. The apparatus according to claim 8, wherein the at least one memory and the computer program code are configured, with the at least one processor, to cause the apparatus to:
perform the transmitting of the network slice to network slice access stratum group mapping in response to determining that the first and second cells are configured with different network slice to network slice access stratum group mappings or at least with potentially different network slice to network slice access stratum group mappings.

10. The apparatus according to claim 8, wherein the at least one memory and the computer program code are configured, with the at least one processor, to cause the apparatus to further perform:
maintaining, in the at least one memory, configuration information on the first and second cells, wherein the configuration information comprises at least tracking areas of the first and second cells; and
performing the transmitting of the network slice to network slice access stratum group mapping in response to determining that the first and second cells are under different tracking areas based on the configuration information.

11. The apparatus according to claim 5, wherein the at least one memory and the computer program code are configured, with the at least one processor, to cause the apparatus to further perform:
maintaining, in the at least one memory, configuration information on the second cell, wherein the configuration information comprises at least a tracking area of the second cell;
receiving information on a registration area of the terminal device from a core network node, in the case of the intra-central unit handover, or from the first central unit, in the case of the inter-central unit handover; and
performing the transmitting of the network slice to network slice access stratum group mapping in response to determining that the tracking area of the second cell does not belong to the registration area of the terminal device.

12. The apparatus according to claim 5, wherein the at least one memory and the computer program code are configured, with the at least one processor, to cause the apparatus to further perform:
maintaining, in the at least one memory, configuration information on the second cell, wherein the configuration information comprises at least a network slice to network slice access stratum group mapping of the second cell;
receiving one or more network slice to network slice access stratum group mappings for one or more tracking areas within a registration area of the terminal device from a core network node; and
performing the transmitting of the network slice to network slice access stratum group mapping in response to determining that a current network slice to network slice access stratum group mapping of the terminal device differs from a network slice to network slice access stratum group mapping of the second cell.

13. The apparatus according to claim 5, wherein the first and second distributed units are distributed units of a first distributed access node and thus the intra-central unit handover is determined to be carried out and the at least one memory and the at least one memory and the computer program code are configured, with the at least one processor, to cause the apparatus to perform:
maintaining, in the at least one memory, configuration information on the first and second cells, wherein the configuration information comprises at least network slice to network slice access stratum group mappings of the first and second cells; and
performing the transmitting of the network slice to network slice access stratum group mapping in response to determining that the network slice to network slice access stratum group mapping of the first cell differs from the network slice to network slice access stratum group mapping of the second cell.

14-17. (canceled)
